(19) United States
(12) Patent Application Publication
(10) Pub. No.: US 2019/0018918 A1
(43) Pub. Date: Jan. 17, 2019

(54) SYSTEM AND METHOD FOR PERFORMING ACCURATE HYDROLOGIC DETERMINATION USING DISPARATE WEATHER DATA SOURCES

(71) Applicant: THE TRUSTEES OF PRINCETON UNIVERSITY, Princeton, NJ (US)

(72) Inventors: Eric Franklin WOOD, Princeton, NJ (US); Justin SHEFFIELD, Winchester (GB); Ming PAN, Princeton, NJ (US); Colby Kipp FISHER, Lawrenceville, NJ (US); Nathaniel Wilkins CHANEY, Lawrenceville, NJ (US); Jonathan Drew HERMAN, Woodland, CA (US); Hylke Edward BECK, Plainsboro Township, NJ (US)

(73) Assignee: THE TRUSTEES OF PRINCETON UNIVERSITY, Princeton, NJ (US)

(21) Appl. No.: 16/030,349

(22) Filed: Jul. 9, 2018

Related U.S. Application Data
(60) Provisional application No. 62/530,948, filed on Jul. 11, 2017.

(51) Int. Cl. G06F 17/50; G06F 17/18; G06F 17/30

(52) U.S. Cl. CPC G06F 17/5036; G06F 17/30371; G06F 17/30241; G06F 17/18

(57) ABSTRACT

A computerized hydrologic modeling system and method for performing accurate hydrologic determination using disparate weather data sources. Weather observation data are received for a geographical region, the weather observation data comprising data having a first temporal and spatial resolution for a first parameter set. Weather model data are received for the geographical region, the weather model data comprising data having a second temporal and spatial resolution for a second parameter set. Either the weather observation data or the weather model data or both are processed to provide a common scale dataset having a common temporal and spatial resolution for the parameters of the first and second parameter sets. A historical dataset is retrieved comprising historical observation data for the first and second parameter sets. The common scale dataset is bias-corrected to be statistically consistent with the historical observation data. The bias-corrected common scale dataset is stored in the memory for reference for determination purposes.

### CROSS-REFERENCE TO RELATED APPLICATION

This application is based on and derives priority from U.S. Provisional Patent Application No. 62/530,948, filed Jul. 11, 2017, the entire contents of which are incorporated by reference herein.

### FIELD OF THE INVENTION

The present invention relates generally to hydrologic modeling and hydrologic forecasting, and more particularly, to a computerized system and method for performing accurate hydrologic forecasting and other determining using disparate sources of weather data.

### BACKGROUND

Weather forecasting, and hydrologic forecasting, are important for various commercial, agricultural, industrial and recreational purposes. Various methods exist for performing weather forecasts (such as regional precipitation forecasts), and hydrologic forecasts (such as forecasts of droughts, floods and water availability).

Such forecasts are often based at least in part on historical data, and/or weather observations. For example, NASA provides access to weather observation data gathered by a weather satellite (TRMM TMPA 3B42RTv7), which provides data representing global observations of precipitation data recorded at a predetermined resolution, e.g., 0.25 degree regions at 3-hour intervals. By way of alternative example, weather model data is available from NASA and or NOAA in accordance with a global forecast model, which involves use of a mathematical model to produce temperature and surface wind speed data points at a predetermined resolution, e.g., 1.0 degree region at 6-hour intervals. By way of further example, ground observations, such as rain gauge data, are publicly available data sources available from NOAA and/or USGS in the United States, e.g., to provide data representing actual recorded rainfall at disparate geographical locations where such rain gauges are physically disposed. Still further, historical data, over multi-year periods, exist that provide observations of precipitation, temperature and wind speed at a predetermined resolution, such as 0.25 degree regions at 1-day intervals. Each of these datasets, taken individually, may be useful for performing weather and/or hydrologic forecasts. However, each dataset, and resulting forecasts, are subject to certain limitations or inaccuracies inherent to each dataset, resolution and/or modeling approach. Accordingly, making predictions of hydrologic conditions based on one specific data source alone will allow for the errors of that dataset to propagate into all derived data products and predictions. Avoiding such inaccuracies is especially important when attempting to predict extreme hydrologic conditions, such as floods or droughts, for which a high degree of accuracy is desirable so that responders, stakeholders and policy makers can be properly informed.

What is needed is a system and method for performing hydrologic determination of global terrestrial hydrology with increased accuracy.

### SUMMARY

The present invention provides a system and method for performing hydrologic determination using disparate weather data sources (e.g., in-situ observations, remotely-sensed (e.g., satellite) observations, and model data resulting from mathematical weather and climate models) in a manner that increases overall forecast accuracy by effectively combining the datasets to eliminate or mitigate inherent limitations or inaccuracies existing in each individual dataset. More particularly, the present invention provides a system and method for modeling hydrologic processes for determination purposes that involves retrieval of remote sensing weather observations, selectively downscaling data from the datasets to harmonize them to common (finer) temporal and spatial scales, bias-correcting the common-scale data to make the common-scale data statistically consistent with a long-term historical dataset, and performing global hydrologic modeling and determination with increased accuracy as a function of the bias-corrected common-scale dataset.

### BRIEF DESCRIPTION OF THE FIGURES

An understanding of the following description will be facilitated by reference to the attached drawings, in which:

FIG. 1 is a diagrammatic view of an exemplary networked computing environment implementing systems and methods for performing accurate hydrologic determination using disparate weather data sources in accordance with the present invention;

FIG. 2 is a diagrammatic view of an exemplary Hydrologic Modeling System performing data refinement using disparate weather data sources in accordance with the present invention; and

FIG. 3 is a flow diagram illustrating an exemplary method for performing accurate hydrologic determination using disparate weather data sources in accordance with the present invention.

### DETAILED DESCRIPTION

The present invention provides a computerized system and method for performing accurate hydrologic determination using disparate weather data sources in accordance with the present invention.

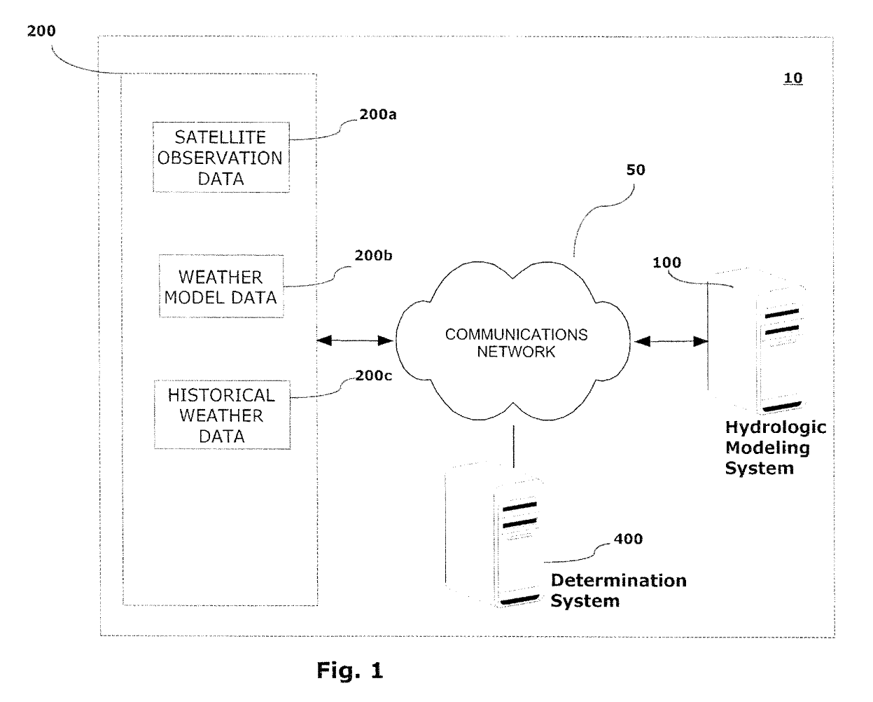

Referring now to FIG. 1, a diagrammatic view of an exemplary networked computing environment 10 is shown for implementing the systems and methods for performing accurate hydrologic determination using disparate weather data sources in accordance with the present invention. As shown in FIG. 1, the networked computing environment includes a Hydrologic Modeling System (HMS)
100 and a Determination System (OS) 400. The HMS 100 communicates via a communications network 50 with disparate data sources 200, to retrieve or otherwise receive data for further processing, analysis and/or storage, as described herein.
The OS 300 communicates via the communications network 50 with the HMS 100 to perform purpose-specific forecasts. Accordingly, for example, the HMS 100 may process data from disparate data sources to prepare data for use for determination purposes, and the OS 400 may perform such forecasts using data provided by the HMS 100. By way of example, the HMS 100 may make its processed data available as part of a commercially-available service, so that independent operators of OS 300 may access and perform forecasts according to their unique goals and desires. By way of alternative example, the functionality of HMS 100 and OS 400 may be combined into a unitary system and may be performed on behalf of a single party.

The components of the networked environment 10 can be interconnected in any suitable configuration, using any suitable type of connection and conventional communications hardware and software. The components may be connected directly or over a network 50, which may be any suitable network. For example, one or more portions of network 50 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

The components of the networked environment 10 may be connected to each other using any suitable communication connections. For example, suitable connections include wireline (e.g., DSL or DOCSIS), wireless (e.g., WiMAX), and optical (e.g., SONET SOH) connections. For example, one or more connections may include an intranet, extranet, VPN, LAN, WAN, cellular telephone network or other type of connection or combination of connections.

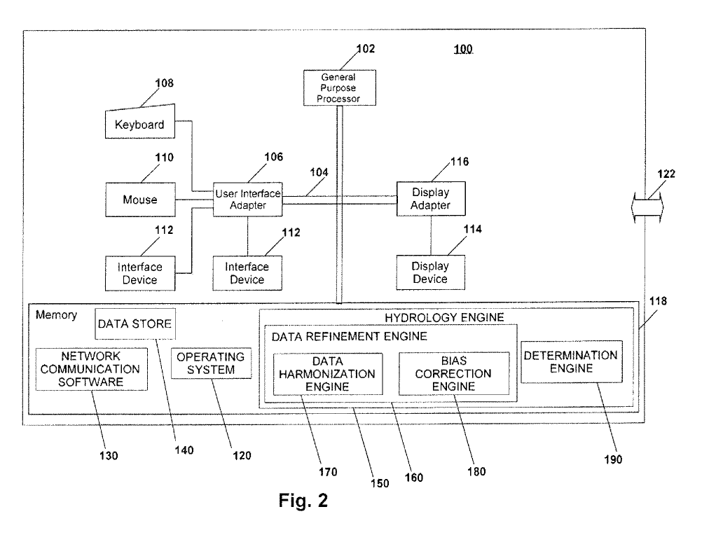

As will be appreciated from FIG. 2, the HMS 100 may be generally conventional in that it includes conventional computing hardware and software for general operation. FIG. 2 is a block diagram showing an exemplary HMS 100 in accordance with an exemplary embodiment of the present invention. The HMS 100 is a special-purpose computer system that includes conventional hardware, e.g. one or more processors, memory hardware storing and executing both conventional software enabling operation of a general purpose computing system, such as operating system software 120 and network communication software 130, and specially-configured computer software for configuring the general purpose hardware as a special-purpose computing system for carrying out at least one method in accordance with the present invention.

Accordingly, the personal computing device FIG. 2 includes a general-purpose processor, such as a microprocessor (CPU) 102 and a bus 104 employed to connect and enable communication between the processor 102 and the components of the presentation system in accordance with known techniques. The exemplary HMS 100 includes a user interface adapter 106, which connects the processor 102 via the bus 104 to one or more interface devices, such as a keyboard 108, mouse 110, and/or other interface devices 112, which can be any user interface device, such as a touch sensitive screen, digitized entry pad, etc. The bus 104 also connects a display device 114, such as an LCD screen or monitor, to the processor 102 via a display adapter 116. The bus 104 also connects the processor 102 to memory 118, which can include solid state memory, a hard drive, diskette drive, tape drive, etc.

The HMS 100 may communicate with other computers or networks of computers, for example via a communications channel, network card or modem 122. The HMS 100 may be associated with such other computers in a local area network (LAN) or a wide area network (WAN), and may operate as a client in a client/server arrangement with another computer, etc. Such configurations, as well as the appropriate communications hardware and software, are known in the art.

The HMS 100 is specially-configured in accordance with the present invention in that it includes a Hydrology Engine (HE) application 150 comprising computer-readable, processor-executable instructions stored in the memory for carrying out the methods described herein. Further, the memory stores certain data, e.g. in a database or other data store 140 shown logically in FIG. 2 for illustrative purposes, without regard to any particular embodiment in one or more hardware or software components. Optionally, other software and/or data may be stored in a corresponding data store 140 of the memory 118. The HE 150 receives and processes data in accordance with the teachings of the present invention. Accordingly, the HE 150 includes rules and logic implementing the analysis and method steps described herein.

Notably, the HE 150 includes a Data Refinement Engine (ORE) 160. The ORE 160 is configured to produce a bias-corrected common-scale dataset that can be used for accurate hydrologic determination in accordance with the present invention. In accordance with the present invention, the ORE includes a Data Harmonization Engine (DHE) 170 that is configured to receive disparate weather data from disparate data sources, the data having different temporal and spatial resolutions/scales, and to harmonize the data (e.g., by downscaling) to produce a common-scale dataset. Further, in accordance with the present invention, the ORE 160 includes a Bias Correction Engine (BCE) 180. The BCE 180 is configured to bias-correct the common-scale dataset to make the common-scale data statistically consistent with a long-term historical dataset. Bias-correcting to statistically conform the data to long-term historical observations reduces and/or eliminates errors and/or inaccuracies resulting from the individual datasets. In this manner, the ORE 160 allows for increased overall forecast accuracy by effectively combining and bias-correcting disparate datasets to eliminate or mitigate inherent limitations or inaccuracies existing in each individual dataset.

In this exemplary embodiment, hydrologic and related determination may be performed by the HMS 100, accordingly, the exemplary embodiment shown in FIG. 2 includes an optional Determination Engine (DE) 190 configured to use the bias-corrected common scale dataset to perform modeling and hydrologic forecasting with increased accuracy. In other embodiments, the DE 190 may be located at the Determination System 400, and such forecasting may not be performed at the HMS 100.

The Determination System 400 may include conventional hardware and software, as described above with reference to HMS 100, but may include only a Forecasting Engine 190, rather than the entire Hydrology Engine 150 described above with reference to FIG. 2. In this context, the HMS 100 prepares the bias-corrected common scale dataset, and the Determination Engine 190 of the Determination System 400 uses the bias-corrected common scale dataset to perform accurate hydrologic or other forecasts as a function of the bias-corrected common scale dataset, e.g. by communication with the HMS 100 via the communications network 50.

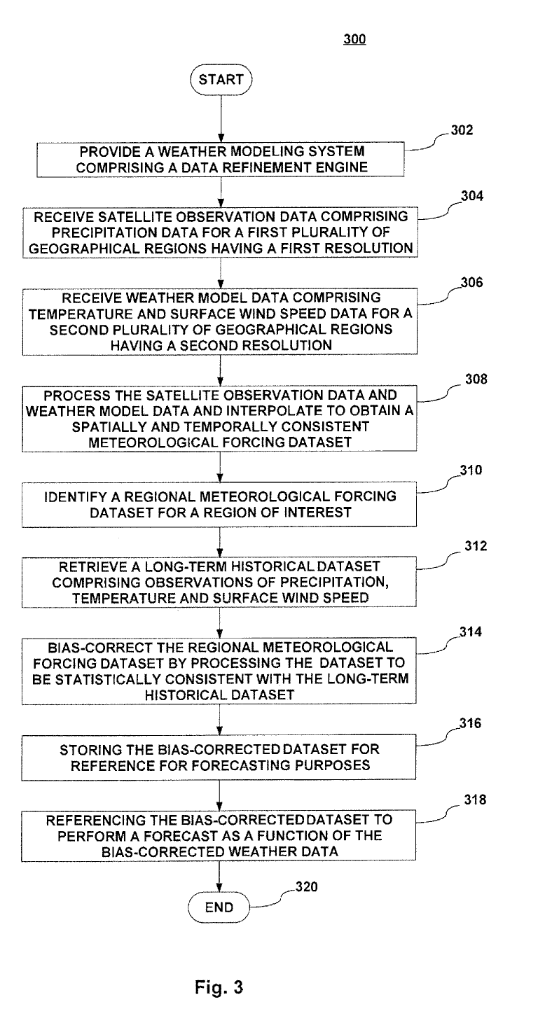

Referring now to FIG. 3, a flow diagram 300 is provided that illustrates an exemplary method for performing accurate hydrologic determination using disparate weather data sources in accordance with the present invention. As shown in FIG. 3, this exemplary method begins with providing a Hydrologic Modeling System (HMS) 100 comprising a Data Refinement Engine (ORE) 160 in accordance with the present invention, as shown at 302.

Next, the method involves receipt at the HMS 100 of remotely-sensed Earth weather observation data for a first plurality of geographical regions, as shown at 304. In this example, the remotely-sensed Earth weather observation data comprises satellite observation data comprising precipitation data. Suitable data is publicly/commercially-available, such as weather satellite data from NASA satellite mission TRMM TMPA 3B42RTv7. Any suitable data source may be used. This data has a first resolution, namely, a first temporal and spatial resolution. This first resolution is the result of the existing conventional processes for compiling this data in commercially- (or publicly-) available form. In the example of NASA TRMM TMPA 3B42RTv7, precipitation data is available with a 0.25 degree spatial resolution, and a 3-hour interval temporal resolution. Further, this data is available in near real-time, meaning that the data is generally available within 6 hours to within 5 days of actual observation. This data is received for a first plurality of geographical regions, which may be, for example, a specific country (e.g., United States), continent (e.g., Africa) or globally. This data may be stored in the data store 140 of the HMS 100 for subsequent processing by the ORE 160, as described below.

Next, the method involves receipt at the HMS 100 of mathematical model data for a second plurality of geographical regions, as shown at 306. In this example, the mathematical model data comprises model data comprising temperature and terrestrial surface wind speed data. Suitable data is commercially- (or publicly-) available, such as model data available from NASA or NOAA and resulting from a global weather model (e.g., GFS or GEFS). Any suitable data source may be used. This data has a second resolution, namely, a second temporal and spatial resolution. This second resolution is the result of the existing conventional processes for compiling this data in commercially-available form. This second resolution may be the same or different from the first resolution, but is typically different from the first resolution. In the example of the NOAA National Centers for Environmental Prediction GFS (Global Forecast System) data, temperature and surface wind speed data is available with a 1.0 degree spatial resolution, and a 6-hour interval temporal resolution. Further, this data is available in near real-time. This data is received for a plurality of geographical regions. This second plurality of geographical regions may be the same as or different from the first plurality of geographical regions, but preferably is the same, or at least includes overlapping geographical regions. This data may be stored in the data store 140 of the HMS 100 for subsequent processing by the ORE 160, as described below.

Optionally, additional datasets may be used, though not shown in the exemplary embodiment of FIG. 3. For example, ground observation data from ground-based rain gauges, etc. may be received, and such data may have its own temporal and spatial resolution, and may be retrieved for a third geographical region.

Because in this embodiment the first and second resolutions are different, the exemplary method next involves the HMS 100 (and more particularly, the Hydrology Engine 150) processing the datasets (in this example, the referenced satellite observation data and the referenced weather model data) to obtain a spatially- and temporally-consistent meteorological forcing dataset, as shown at 308. More particularly, the satellite observation data may be considered to have high temporal (3-hour intervals) and high spatial (0.25 degree) resolution, while the weather model data may be considered to have low temporal (6-hour intervals) and low spatial (1.0 degree) resolution, relative to one another. This may involving upscaling, or preferably downscaling, the resolution of one or more datasets. Any suitable mathematical or statistical techniques, such as bi-linear interpolation, may be used for this purposes. This processing to produce a common scale dataset is performed by the Data Harmonization Engine 170 of the ORE 160.

In a preferred embodiment, the data is processed to produce a spatially and temporally consistent meteorological forcing dataset having temporal and spatial resolution matching the temporal and spatial resolution of a long term historical data set, which will be used for bias correction purposes as discussed below. The spatially and temporally consistent data set has a common scale—namely, identical spatial and temporal scales/resolutions/intervals. Alternatively, the data may be processed to produce a meteorological forcing dataset having temporal and spatial resolution greater than that of the referenced long term historical data set, and further data processing may be performed to conform the datasets to a common resolution. By way of example, temporal resolution as frequently as hourly, and spatial resolution of approximately 10 km (e.g., for a global modeling case) or of approximately 4 km (for a US modeling case) may be used. In this example, the temperature and wind model data are processed to be spatially and temporally consistent with the satellite observation data by a suitable method of interpolation, such as bi-linear interpolation, to a spatial resolution of 0.25 degrees, and then aggregating the data to a daily temporal resolution, because the historical dataset to be used for bias correction has a spatial resolution of 0.25 degrees and a temporal resolution of 1-day. Matching the resolution for the meteorological forcing dataset to that of the historical dataset is advantageous for further mathematical processing for the purposes described herein. Any suitable region of interest may be used, depending upon determination objectives, processing resources, and or other factors. By way of example, a region of interest may comprise a town, a zip code, a state, a country, a continent, a region defined by latitude/longitude coordinates, or other the entire globe.

Optionally, data and/or file formats may be converted at this time to facilitate distribution, manipulation and/or other processing. For example, file formats may be changed from NASA/NOAA-supplied formats (e.g., HDFEOS or GRB) to more conventional file formats, such as NetCDF. This format conversion may be performed by the Data Harmonization Engine 170.

Next, the exemplary method involves identifying a regional meteorological forcing dataset for a region of interest, as shown at 310. This may be performed by the HE 150 in response to input provided by a user for a particularly analysis. For example, if a user provides input to the HMS 100 indicating that the user wishes to perform a forecast/analysis for the African continent geographical region, then this step involves the HE 150 identifying a subset of the meteorological forcing dataset containing data associated only with the African continent geographical region. This provides a smaller relevant dataset that facilitates subsequent data analysis. This regional meteorological forcing dataset may be stored in the data store 140 for further processing by the HE 150 or its subcomponents.

Next, the exemplary method involves receiving or retrieving a long-term historical dataset comprising multiple observations and reanalysis (e.g., historical weather model runs) of the same parameters (in this case, precipitation, temperatures and surface wind speed), as shown at 312. This may be performed by the HE 150 in response to input provided by a user for a particular analysis. Suitable datasets are commercially available for this purpose. This dataset has its own resolution for such observations. In this example, the Princeton Global Meteorological Forcing Dataset (PGMFD) (which includes precipitation, temperature and surface wind speed observations from Jan. 1, 1948 to Dec. 31, 2010) is used. This dataset has a spatial resolution of 0.25 degrees and a temporal resolution of 1 day. This dataset is a long-term historical dataset in that it is self-consistent over a multi-year period, and preferably over a multi-decade period, and in the case of the PGMFD dataset, over a 62-year period. Because this dataset includes actual historical observations over a long term, it is statistically meaningful and useful for identifying actual overall trends in these parameters, and for performing associated bias correction to constrain new observations and make them more “realistic”, and thus more useful for modeling and determination. In general, long term historical datasets with longer periods of record (e.g. PGMFD) have included more observational data sources and have gone through more quality checks and thus have better data quality than more recently processed information (e.g. NASA's TMPA satellite precipitation). These data sources inherently have different statistical characteristics throughout the period of observation due to errors in the instruments used, environmental conditions, or sampling procedures, for example. If a recent dataset, such as the TMPA satellite precipitation, is identified to have a strong bias in the observations of precipitation versus the long term historical dataset, it is advantageous to remove this bias such that the analysis can be continued through the entire period of record for all data sources used.

Next, the exemplary method involves bias-correcting the regional meteorological forcing dataset for the region of interest by processing the dataset to be statistically consistent with the long term historical dataset, as shown at 314. This is performed by the BCE 180 of the HMS 100, and can be performed using predetermined logic, using conventional statistically approaches. By way of example, this may involve using the statistical method of Cumulative Distribution Function (CDF) matching to obtain an optimal dataset of meteorological forcing data useful for determination (e.g., hydrologic prediction). Any suitable mathematical or statistical technique may be used for this purpose, as will be appreciated by those skilled in the art.

In this example, this bias-corrected regional meteorological forcing dataset for a region of interest is then stored in the data store 140, as shown at 316, e.g., by BCE 180. Accordingly, at this point, the HMS 100 has prepared a more accurate, bias-corrected common scale dataset, based on data from disparate data sources, that is useful for performing more accurate weather and/or hydrologic determination. This data may be stored and made commercially available to third parties for access to perform their own analyses and/or forecast, e.g., on a secure login-based subscription basis, that provides limited access to the data for analysis purposes, e.g., to Determination System 400, FIG. 1. Alternatively, the HMS 100 itself may perform such analyses and/or forecasts, e.g., using Determination Engine 190, such that the output from the HMS 100 is the analysis/forecast itself.

Once the bias-corrected dataset has been created, it can be used for various purposes. Examples discussed herein involve use of the data to perform hydrologic determination to provide a current state and forecast of hydrologic conditions. However, the bias-corrected dataset may be used along with other models for other purposes, as will be appreciated by those skilled in the art.

In this exemplary method, the method next includes referencing the bias-corrected regional meteorological forcing dataset for the region of interest and performing a hydrologic determination, which could be a determination, estimation, prediction or forecast in the past, present, or future, (collectively, “determination”) as a function of the referenced bias-corrected common scale regional meteorological forcing dataset for the region of interest, as shown at 318 and the exemplary method ends, as shown at 320. In this example, this is performed by the Determination Engine 190. The determination data may be stored in the data store 140 and/or be transmitted via the communications network 50, e.g., to a separate and independently controlled Determination System 400, as shown in FIG. 1, or another system.

By way of example, the bias-corrected data set may be used to predict daily hydrologic conditions for a region of interest. Examples of daily or temporally finer hydrologic conditions include soil moisture(%) at various depths, evaporation (mm/day), surface runoff (mm/day), baseflow (mm/day), streamflow (ems), net radiation (W/m*2), net long wave radiation (W/m*2), or net short wave radiation (W/m*2). Further, these conditions may be predicted in near-real time using a land surface model (such as the well-known Variable Infiltration Capacity Model). Optionally, this model may be configured to include a specifically parameterized representation of physical hydrologic processes on the land surface. The models may be configured to be specifically parameterized as will be appreciated by those skilled in the art.

By way of further example, the predicted daily hydrologic conditions may be processed to derive a set of indices useful for hydrologic extremes, such as droughts and floods. Examples of such indices include: standardized precipitation indices (SPI) of 1, 3, 6 and 12 months; a drought index (essentially 2-layer soil moisture percentiles), streamflow percentiles, reference crop evaporation, and NDVI percentiles. These indices may be derived according to any suitable known technique, but such techniques will yield better, more accurate results in accordance with the teachings of the present invention because they are based on the better, more accurate bias-corrected data determined as described herein. The predicted hydrologic condition and indices data may then be processed to create averaged monthly and yearly datasets, which have commercial value, and may be made available for use for analyses.

In the context of short term determination, the HMS 100 may receive a high temporal, low spatial resolution data set for global forecasts of precipitation, temperature and surface wind speed derived from a global weather model (e.g., NCEP GFS), for example, where each individual observation represents a 1.0 degree region over a 3-hour time period for a determination window of 7 days from the present. In such context, the HMS 100 may pre-process the received data to a binary format and extract data for a region of interest to obtain forecast meteorological forcing data. Then, the forecast meteorological forcing data may be processed to be statistically consistent with a long term global historical data set, as described above, by correcting for bias using the statistical method of Cumulative Distribution Function (CDF) matching to obtain a refined dataset of forecast meteorological forcing data useful for hydrologic determination. Then, hydrologic conditions may be predicted, and indices may be derived, as a function of the bias-corrected forecast meteorological forcing data. The system may then post-process all forecasts generated to a common format (e.g., NetCDF) files for easier access and rapid distribution.

In the context of seasonal determination, the HMS 100 may receive a low temporal, low spatial resolution forecast dataset for global seasonal forecasts of monthly precipitation and temperature derived from an ensemble of global climate models [e.g., CFS/NMME] containing one or more of the following models for a determination window of 6 months from the present:

A. CMC1-CanCM3, 10 ensembles at a spatial resolution of 0.25 deg.

B. CMC2-CanCM4, 10 ensembles at a spatial resolution of 0.25 deg.

C. COLA-RSMAS-CCSM3, 6 ensembles at a spatial resolution of 0.25 deg.

D. GFDL-CM2p1-aer04, 10 ensembles at a spatial resolution of 0.25 deg.

E. NASA-GMA0-06012, 11 ensembles at a spatial resolution of 0.25 deg.

F. CFSv2, 24 ensembles at a spatial resolution of 1.0 deg. interpolated to 0.25 deg.

G. A weighted average of all above model ensembles where each model receives an equal or different weight.

In such a context, the HMS 100 may then process the forecast dataset to be statistically consistent with a long term global historical data set, as described above, and a data set for historical monthly hindcasts for each individual model by correcting for bias using the statistical method of Cumulative Distribution Function (CDF) matching to obtain a bias-corrected dataset of seasonal forecast precipitation and temperature. The HMS 100 may then process the bias-corrected dataset of seasonal forecasts to compute 1, 3, 6, and 12 month SPI for each model and monthly temperature anomalies relative to the long term historical database. The system may then post-processing all forecasts generated to common format (e.g., NetCDF) files for easier access and rapid distribution.

In the context of determining drought as a function of satellite observations of global vegetation, the HMS 100 may receive a dataset comprising a low temporal, high spatial resolution dataset of global observations of surface reflectance data retrieved from an observation satellite [e.g., MODIS] where each individual observation represents a 0.25 degree region over a 1-day period in near real-time. In this context, the HMS 100 may pre-process the global reflectance observation data by computing a Normalized Difference Vegetation Index (NDVI), and then by post-processing the NDVI data to create a 30-day composite, and by generating common format (e.g., NetCDF) files for easier access and distribution. By changing the spatial resolution and aggregating in time, this provides a data product that can be referenced for determination purposes to provide a better indication of the current hydrologic conditions as seen by observing vegetation from satellites. By way of example, this dataset may be stored and the HMS 100 and accessed for determination purposes by the Determination System 400, of FIG. 1.

In the context of determining drought as a function of satellite observations of soil moisture, the HMS 100 may receive a dataset comprising a low temporal, high spatial resolution dataset of global observations of soil moisture retrieved from an observation satellite [e.g., SMAP] where each individual observation represents a 0.25 degree region over a 1-day period in near real-time. In this context, the HMS 100 may post-process the soil moisture data to create a 3-day moving average composite, and may then generate common format (e.g., NetCDF) files for easier access and distribution. By changing the spatial resolution and aggregating in time, this provides a data product that can be referenced for determination purposes to provide a better indication of the current hydrologic conditions as seen by observing soil moisture by satellites. By way of example, this dataset may be stored and the HMS 100 and accessed for determination purposes by the Determination System 400, of FIG. 1.

In another embodiment, the present invention may be used to perform flood monitoring, forecasting, or other determination. A corresponding method begins with use of the method of FIG. 3 to obtain current and determined future data for precipitation, temperatures, windspeed and surface radiation generated according to FIG. 3. Next, an initial probability of flooding may be generated, e.g., at Determination System 400, using any off the shelf predictive statistical model for classification. This results in a “first guess” prediction of regions with expected flooding based on precipitation and current conditions (e.g., soil moisture, discharge). By way of example, this may be performed using a machine learning algorithm, such as the random forest classification algorithm. In accordance with this algorithm, a number of input datasets (e.g., predicted rainfall for each grid cell (defined geographic location), a measure of the antecedent (e.g., 3-5 days prior) precipitation, streamflow conditions currently observed and current soil moisture conditions on the ground), which are all at a common temporal and spatial resolution according to the method described herein, are used, and then a corresponding statistical model is trained with this dataset and observed instances of historical flooding. Subsequently, the model is run with data different from the training data, and the resulting output is a classification of whether flooding will occur within a given grid cell (defined geographic location) and the associated probability. Other machine learning algorithms (or statistical model for classification) may be used to achieve a similar goal.

Next, a refined probability of flooding may be generated, e.g., at one hour in advance of the expected flooding event. This step is performed as described above in terms of the model usage. However, in this step, a very short term (and more accurate) forecast of precipitation is used to predict the flooding. If it is concluded that the flooding will occur at this time, processing according to the model chain continues. Otherwise the cycle repeats.

In the event of a predicted flood, a land surface model is run using the forecasted weather conditions to determine future hydrologic conditions on the ground, focusing on surface runoff. For example, this is similar to the methodology described above. For example, this may be performed for a forecast up to 36 hours in advance of a predicted flooding event.

Next, surface water runoff determinations are used as inputs for a dynamic inundation model that predicts the extent of flooding (inundation), water surface elevations and discharges through a smaller region of interest (e.g., a river basin) where flooding is predicted to occur. Various models may be used for this purpose. By way of example, the LISFLood-FP dynamic inundation model maybe used for this purpose. Any other model for 2-dimensional discharge and inundation may be used, and such models are known in the art.

Next, the predicted inundation extend may be repeatedly validated against a satellite-derived inundation extent product to confirm that the dynamic inundation model is capturing flood extents correctly. The remote sensing inundation model referenced above is another application of a random forest classifier model. In this case, satellite passive microwave observations (from a NASA mission such as SMAP) may be used to predict whether or not there is flooding (simply water above the ground surface) in a given grid cell or location. Final conclusions may be determined in automated fashion using predetermined and prestored logic, e.g., of the Determination System 400.

As referenced above, all such data analyses may be performed at the HMS, and subsequent weather and/or hydrologic determinations may be performed at the HMS, or such bias-corrected datasets may be made available for distribution and visualization and/or subsequent processing via a communications network 50 to external Determination Systems 400, e.g., through a custom web platform and set of APis. Resulting predictions/estimations may thereby be made available through a website/data portal, etc. for use by end users, such as governments, first responders, transportation planners, insurance companies, etc., in a manner similar to that describe above.

Additionally, computer readable media storing computer readable code for carrying out the method steps identified above is provided. The computer readable media stores code for carrying out subprocesses for carrying out the methods described above.

A computer program product recorded on a computer readable medium for carrying out the method steps identified above is provided. The computer program product comprises computer readable means for carrying out the methods described above.

Additional information in relation to the present invention is provided in the Appendix hereto.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A computerized hydrologic modeling system for performing accurate hydrologic determination using disparate weather data sources, the system comprising:
a processor;
a memory; and
instructions stored in the memory and executable by the processor to:
receive weather observation data for a geographical region, the weather observation data comprising data having a first temporal and spatial resolution for a first parameter set;
receive weather model data for the geographical region, the weather model data comprising data having a second temporal and spatial resolution for a second parameter set;
process at least one of the weather observation data and the weather model data to provide a common scale dataset having a common temporal and spatial resolution for the parameters of the first and second parameter sets;
retrieve a historical dataset comprising historical observation data for the first and second parameter sets;
bias-correct the common scale dataset to be statistically consistent with the historical observation data; and
store the bias-corrected common scale dataset in the memory for reference for determination purposes.

2. The hydrologic modeling system of claim 1, further comprising instructions stored in the memory and executable by the processor to:
reference the bias-corrected common scale dataset stored in the memory; and
perform a determination, according to predetermined logic stored in a memory, as a function of the bias-corrected common scale dataset.

3. The hydrologic modeling system of claim 1, wherein the instructions stored in the memory and executable by the processor to perform the determination as a function of the bias-corrected common scale dataset comprise instructions for determining daily hydrologic conditions for a region of interest.

4. The hydrologic modeling system of claim 3, wherein the determined daily hydrologic conditions of interest comprises at least one of a soil moisture value an, evaporation value, a surface runoff value, a baseflow value, a streamflow value, a net radiation value, a net long wave radiation value, a net short wave radiation value.

5. The hydrologic modeling system of claim 3, wherein the instructions stored in the memory and executable by the processor to perform the determination as a function of the bias-corrected common scale dataset comprise instructions for performing a determination according to a land surface model.

6. The hydrologic modeling system of claim 5, wherein the land surface model comprises a Variable Infiltration Capacity Model.

7. The hydrologic modeling system of claim 1, wherein the weather observation data received comprises satellite data gathered by a satellite.

8. The hydrologic modeling system of claim 7, wherein the weather observation data comprises data for a precipitation parameter.

9. The hydrologic modeling system of claim 8, wherein the weather model data comprises data for a temperature and terrestrial surface wind speed parameters.

10. The hydrologic modeling system of claim 8, wherein the first temporal and spatial resolution is different from the second temporal and spatial resolution.

11. The hydrologic modeling system of claim 5, wherein the instructions to process at least one of the weather observation data and the weather model data to provide a common scale dataset having a common temporal and spatial resolution for the parameters of the first and second parameter sets comprises instructions to bi-linearly interpolate.

12. The hydrologic modeling system of claim 11, wherein the instructions to bias-correct the common scale dataset to be statistically consistent with the historical observation data comprises instructions to use a statistical function.

13. The hydrologic modeling system of claim 11, wherein the instructions to bias-correct the common scale dataset to be statistically consistent with the historical observation data comprises instructions to use a Cumulative Distribution Function (CDF) matching function.

14. A computerized system for performing accurate hydrologic determination using disparate weather data sources, the system comprising:
a computerized hydrologic modeling system comprising:
a first processor;
a first memory; and
instructions stored in the first memory and executable by the first processor to: receive weather observation data for a geographical region, the weather observation data comprising data having a first temporal and spatial resolution for a first parameter set;
receive weather model data for the geographical region, the weather model data comprising data having a second temporal and spatial resolution for a second parameter set;
process at least one of the weather observation data and the weather model data to provide a common scale dataset having a common temporal and spatial resolution for the parameters of the first and second parameter sets;
retrieve a historical dataset comprising historical observation data for the first and second parameter sets;
bias-correct the common scale dataset to be statistically consistent with the historical observation data; and
store the bias-corrected common scale dataset in the first memory for reference for forecasting purposes; and
a computerized determination system comprising:
a second processor;
a second memory; and
second instructions stored in the memory and executable by the second processor to: reference the bias-corrected common scale dataset; and
perform a determination, according to predetermined logic stored in the second memory, as a function of the bias-corrected common scale dataset.

15. A computerized system for performing accurate hydrologic determination using disparate weather data sources, the system comprising:
a computerized hydrologic modeling system comprising:
a first processor;
a first memory; and
a hydrology engine comprising instructions stored in the first memory and executable by the first processor to:
receive weather observation data for a geographical region, the weather observation data comprising data having a first temporal and spatial resolution for a first parameter set; and
receive weather model data for the geographical region, the weather model data comprising data having a second temporal and spatial resolution for a second parameter set;
a data harmonization engine comprising instructions stored in the first memory and executable by the first processor to:
process at least one of the weather observation data and the weather model data to provide a common scale dataset having a common temporal and spatial resolution for the parameters of the first and second parameter sets; and
a bias correction engine comprising instructions stored in the first memory and executable by the first processor to:
retrieve a historical dataset comprising historical observation data for the first and second parameter sets;
bias-correct the common scale dataset to be statistically consistent with the historical observation data; and
store the bias-corrected common scale dataset in the first memory for reference for determination purposes.

16. The computerized system of claim 15, further comprising:
a determination engine comprising instructions to:
reference the bias-corrected common scale dataset; and
perform a determination, according to predetermined logic stored in the second memory, as a function of the bias-corrected common scale dataset.

17. The computerized system of claim 16, wherein the hydrology engine comprises the determination engine, and the instructions of the determination engine are stored in the first memory.

18. The computerized system of claim 16, further comprising:
a determination system, said determination system comprising:
a second processor; and
a second memory; wherein
said determination system comprises said determination engine, and the instructions of the determination engine are stored in the second memory.

19. A computerized hydrologic modeling method for performing accurate hydrologic determination using disparate weather data sources, comprising:
receiving weather observation data for a geographical region, the weather observation data comprising data having a first temporal and spatial resolution for a first parameter set;
receiving weather model data for the geographical region, the weather model data comprising data having a second temporal and spatial resolution for a second parameter set;
processing with at least one processor either the weather observation data or the weather model data or both to provide a common scale dataset having a common temporal and spatial resolution for the parameters of the first and second parameter sets;
retrieving a historical dataset comprising historical observation data for the first and second parameter sets;
bias-correcting with the at least one processor the common scale dataset to be statistically consistent with the historical observation data; and
storing the bias-corrected common scale dataset in a memory for reference for determination purposes.

20. The hydrologic modeling method of claim 19, further comprising:
referencing the bias-corrected common scale dataset stored in the memory; and
performing with the at least one processor a determination, according to predetermined logic stored in a memory, as a function of the bias-corrected common scale dataset.

21. The hydrologic modeling method of claim 19, wherein the performing of the determination comprises determining with the at least one processor daily hydrologic conditions for a region of interest.

22. The hydrologic modeling method of claim 21, wherein the determined daily hydrologic conditions of interest comprises at least one of a soil moisture value an, evaporation value, a surface runoff value, a baseflow value, a streamflow value, a net radiation value, a net long wave radiation value, a net short wave radiation value.

23. The hydrologic modeling method of claim 21, wherein the performing of the determination comprises performing with the at least one processor a determination according to a land surface model.

24. The hydrologic modeling method of claim 23, wherein the land surface model comprises a Variable Infiltration Capacity Model.

25. The hydrologic modeling method of claim 19, wherein the weather observation data received comprises satellite data gathered by a satellite.

26. The hydrologic modeling method of claim 25, wherein the weather observation data comprises data for a precipitation parameter.

27. The hydrologic modeling method of claim 26, wherein the weather model data comprises data for a temperature and terrestrial surface wind speed parameters.

28. The hydrologic modeling method of claim 26, wherein the first temporal and spatial resolution is different from the second temporal and spatial resolution.

29. The hydrologic modeling method of claim 23, wherein the processing of either the weather observation data or the weather model data or both comprises performing bi-linear interpolation.

30. The hydrologic modeling method of claim 29, wherein the bias-correcting comprises using a statistical function.

31. The hydrologic modeling method of claim 29, wherein the bias-correcting comprises using a Cumulative Distribution Function (CDF) matching function.
